(19) United States
(12) Patent Application Publication
(10) Pub. No.: US 2021/0086940 A1
(43) Pub. Date: Mar. 25, 2021

(54) OBJECT HOLDER AND ALIGNMENT CRADLE

(71) Applicant: Susan Valerie Dench, Portland, ME (US)

(72) Inventor: Susan Valerie Dench, Portland, ME (US)

(21) Appl. No.: 16/577,180

(22) Filed: Sep. 20, 2019

(51) Int. Cl. B65D 1/36

(52) U.S. Cl. CPC B65D 1/36

(57) ABSTRACT

The applicant's Disclosure describes a tray cradle for holding and aligning objects. The tray enables the user to support, stabilize and work on and with odd shaped and different size objects and with liquids (such as paint). The tray has folding legs and grid markings. It is made of flexible, non-stick, solvent resistant material formed into the supporting tray and multiple individual dome shaped receptacles (with optional caps) that can be used for support or to hold material or both at the same time.

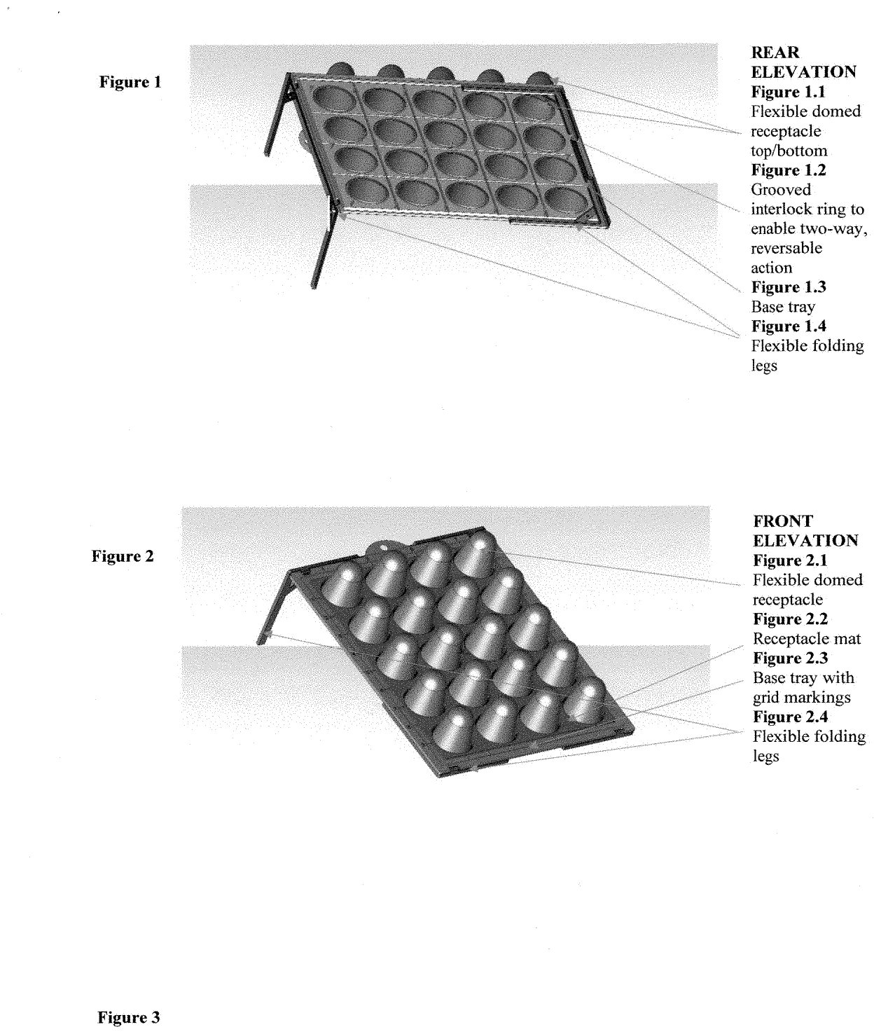

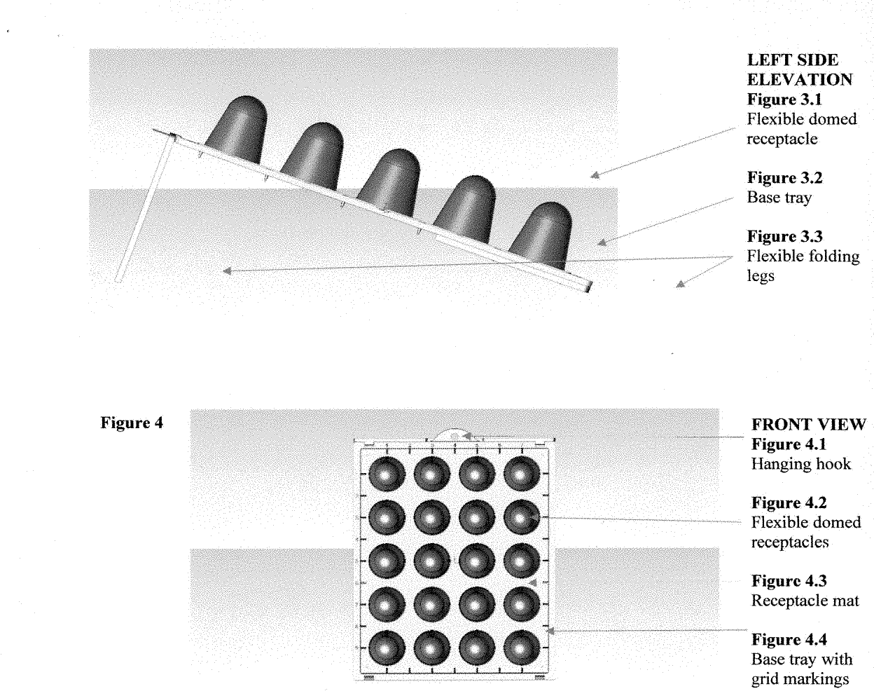

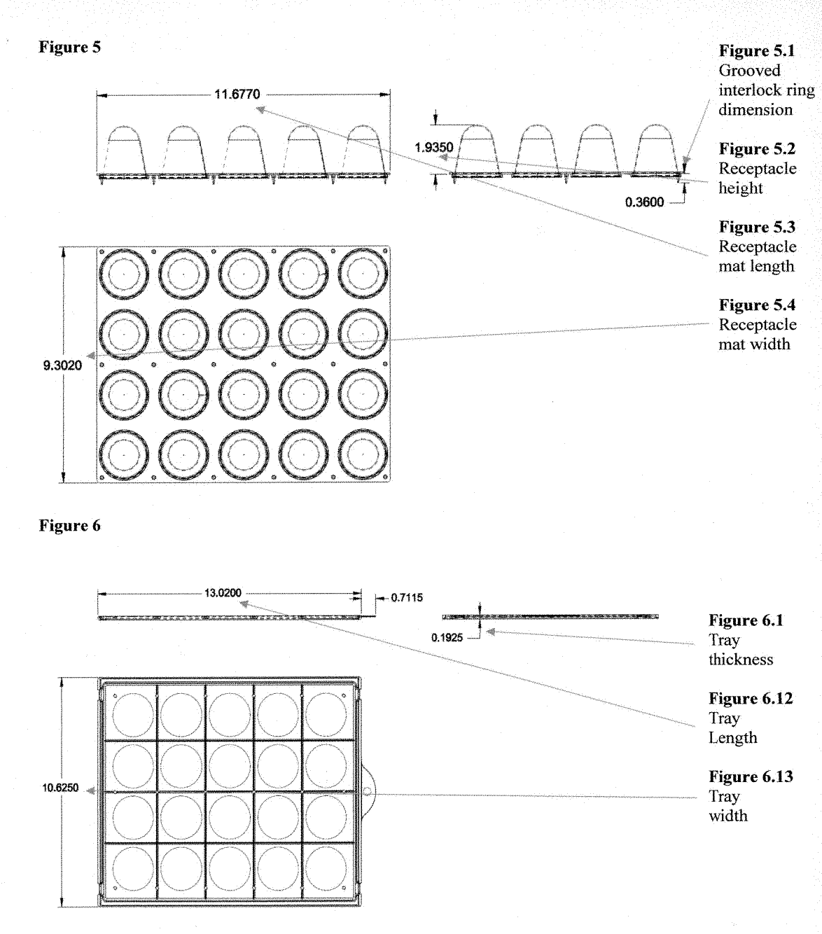

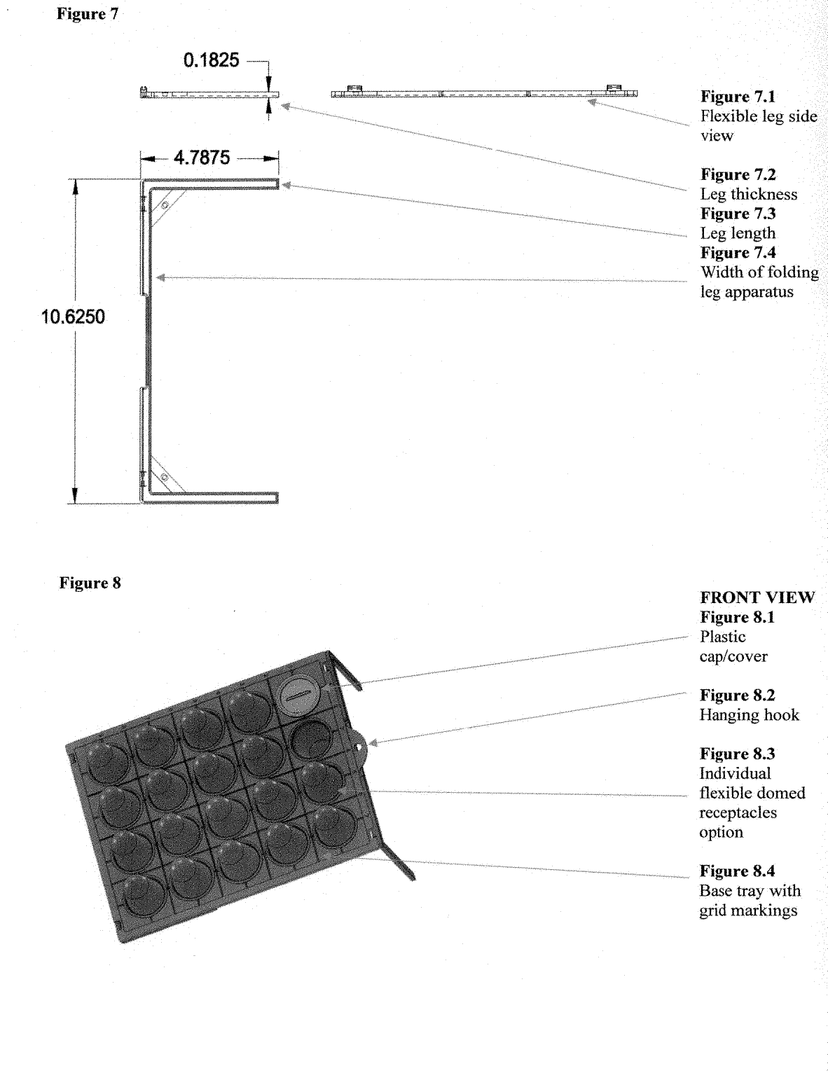

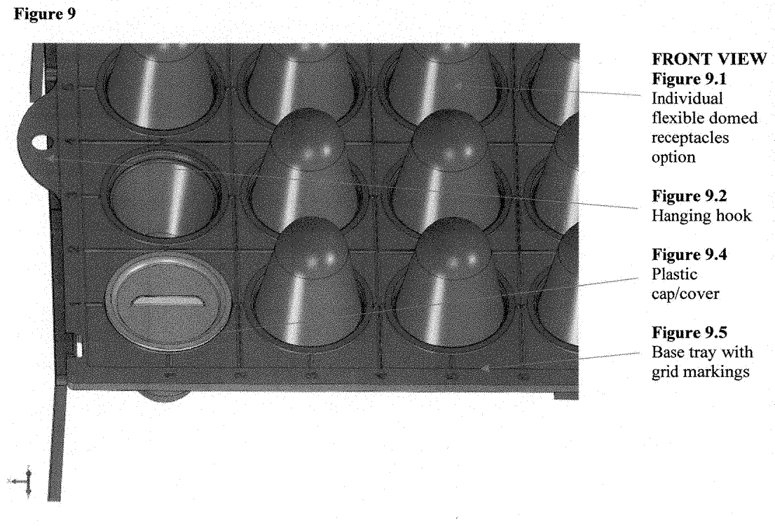

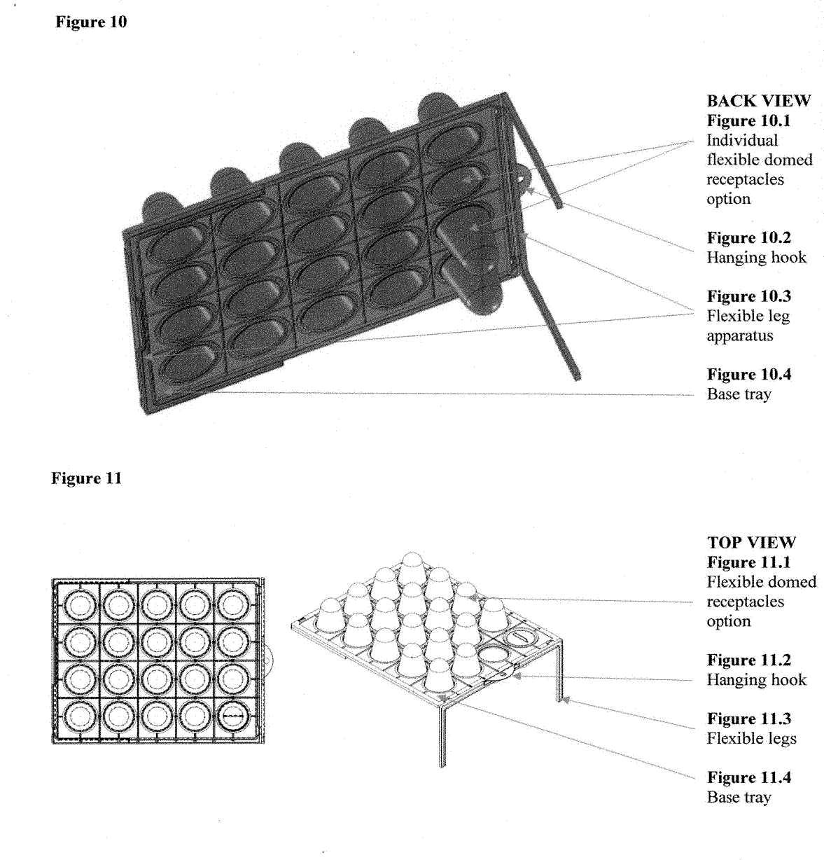

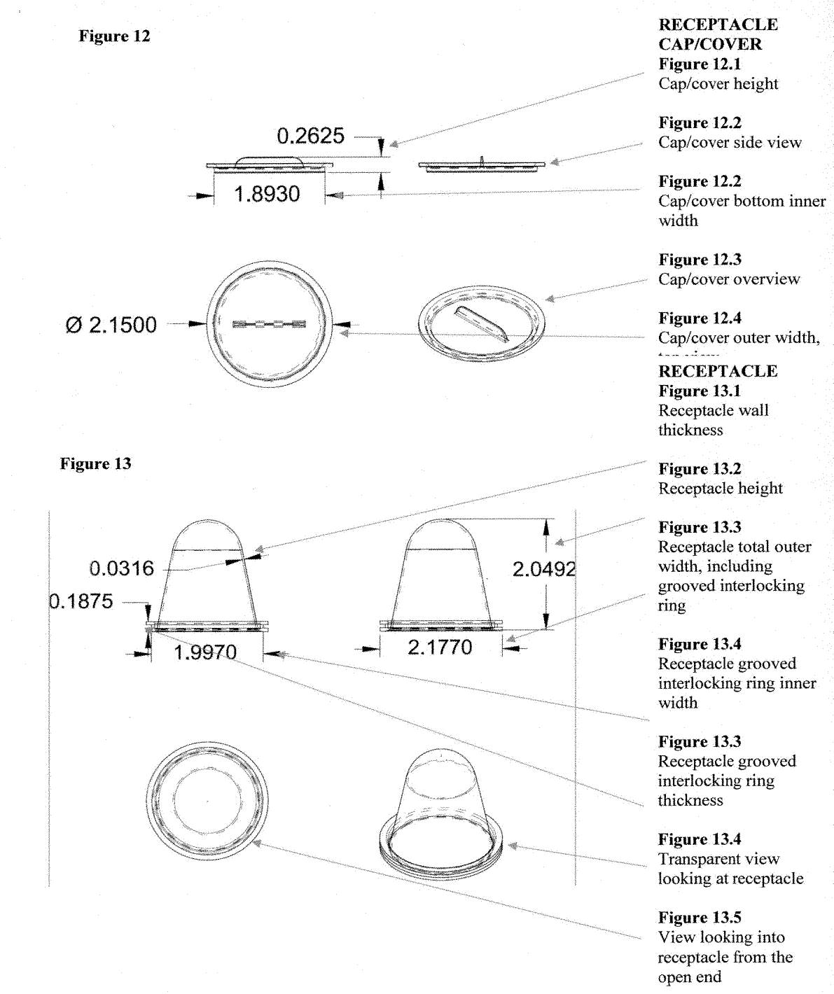

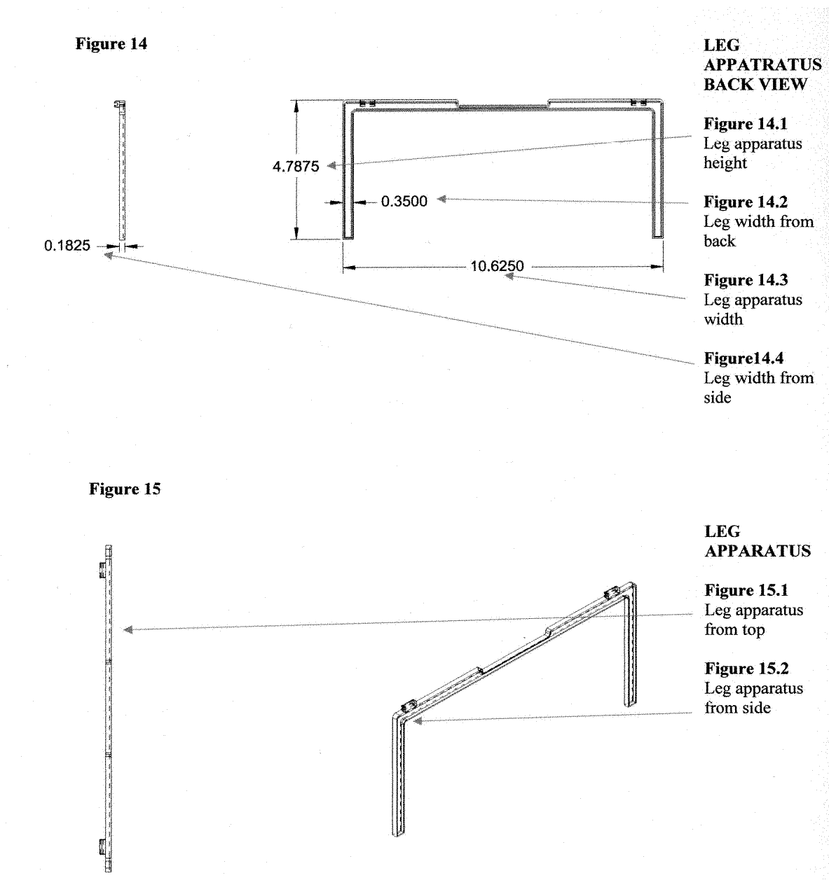

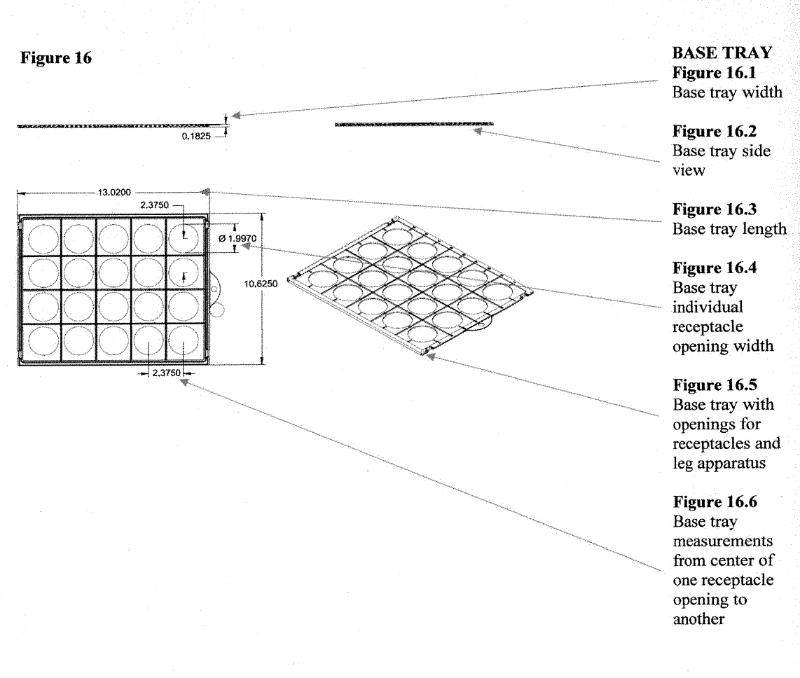

### BACKGROUND

The present invention is a tray for holding and aligning objects: For craft and other projects, decorations are often placed on an object. For example, a glass or mug may have decorative lettering, pictures or art work thereon. There are several challenges with these projects, including having a way to hold or cradle the object so both hands are available and having a way to align the embellishment for a professional result.

Alignment of the decorations on an object has generally relied upon “eyeballing” of the placement of the decoration. For round or irregularly shaped objects, a user will often hold the object between the user's knees to retain the object during the placement of decorations.

It would be helpful to have apparatus for supporting and accurately aligning decorations being placed on supported objects. It would also be beneficial to have any liquids, such as paint or etching cream, or small objects, such as jewelry findings, readily at hand in the same apparatus and contained while working on the project.

The non-stick, solvent resistant apparatus can also be used for household projects. It provides a way to elevate an object being painted, glued or stained off a work surface to easily access the object, ensuring cleaner painted edges and allowing the paint to dry, reducing set up and clean up time, and allowing the project to be completed in one work session. Having flexible, specially shaped domed two-way receptacles keeps objects from slipping without damage to the object and allows for paint, screws and other hardware such as drill bits to be contained at the same time in the same apparatus. Grid markings allow alignment.

### DESCRIPTION

The disclosed holder and aligner tray provides flexibility for working on and with many differing sized and odd shaped objects as well as for liquids at the same time. The holder/aligner comprises multiple flexible two-way domed receptacles with fixed receptacle mat and optional interchangeable receptacles, held in the same multi-functional tray with grid markings, and matching caps for expanded usage.

1. A flexible non-stick, solvent resistant placement and alignment apparatus for receiving and supporting objects of multiple sizes and shapes, into which, upon the realignment of the receptacles, liquids and solid objects can be received simultaneously, comprising:
multiple flexible special domed receptacles made of silicone or thermoplastic elastomer (TPE) either as part of a mat or as individual receptacles which are spaced for receiving objects and multiple components of varying sizes, liquids, or both at the same time, and which turn inside out with two-way, reversable action, acting as holders for multiple components, of special round grooved interlock design, bending & conforming to any shape or form, possible food grade and chemical residences, some versions can use receptacle design contour that can be changed with new and various size and shape designs to fit customer needs, to hold things of any shape, to make things as diverse as ice cubes or candles, to sort hardware items like nuts and bolts, sort hobby items like buttons and beads, paint holders, etc. and
a polyethylene (PE) or polypropylene (PP) tray holding the mat and/or receptacles with measuring grid, borders and numbers raised to be used as is or pad printed, with folding attachable legs to be laid out flat on a table or standing or at a user-defined angle and
with (2) folding legs with a round hinge snap design, 90-degree fold in or out and
with plastic cap/covers for the receptacles to contain liquids and other items placed into cups.
